(19) United States
(12) Patent Application Publication
(10) Pub. No.: US 2014/0230142 A1
(43) Pub. Date: Aug. 21, 2014

(54) TOILET SEAT RISER

(71) Applicant: JOBAR INTERNATIONAL, INC., Carson, CA (US)

(72) Inventors: Tim Alan Baker, Torrance, CA (US); Jaime Archila, Redondo Beach, CA (US)

(73) Assignee: JOBAR INTERNATIONAL, INC., Carson, CA (US)

(21) Appl. No.: 13/773,363

(22) Filed: Feb. 21, 2013

(51) Int. Cl. A61G 7/10; A47K 13/10

(52) U.S. Cl. CPC A61G 7/1007; A47K 13/10
USPC 4/667; 4/237

(57) ABSTRACT

A toilet seat apparatus is provided to assist a user between a standing position and a seated position. In one embodiment, the toilet seat apparatus includes a base portion configured to mount to a toilet bowl proximate a rear portion of the base portion, a biasing mechanism connected to the base portion proximate a forward portion of the base portion, a seat portion hingedly connected to the forward portion of the base portion, the seat portion configured to rotate between a fully inclined position and a closed position, and at least one strut having a first end and a second end opposite the first end, the first end connected to the seat portion and the second end connected to the biasing mechanism, wherein the biasing device biases the seat portion into the inclined position.

### TECHNICAL FIELD

The present invention relates generally to assisted living equipment, and more particularly to a mechanized toilet seat apparatus.

### BACKGROUND OF THE INVENTION

Elderly and disabled individuals commonly have difficulty lowering themselves into a seating position and then rising from said seated position. Such individuals may lack the necessary strength to sit down gently and therefore they are likely to injure themselves if they attempt to sit down unassisted. Moreover, such individuals may lack the necessary strength to stand up from a seated position without assistance. Conventionally, elderly and disabled persons had to rely on handrails or caregivers to support them as they moved between a seated and standing position. However, in-home health care may be prohibitively costly for many users and the use of handrails requires the user to have a high degree of upper body strength.

As such, there is a need for a toilet seat device configured to both assist the user in sitting down on the toilet and to assist the user in standing up from the toilet. Additionally, there is a need for a toilet seat apparatus that is configured to selectively adjust to accommodate the user's particular weight and desired assistance level.

### SUMMARY OF THE INVENTION

The present invention relates generally to assisted living equipment, and more particularly to a mechanized toilet seat apparatus. In an embodiment of the present invention, the seat apparatus includes a base portion configured to mount to a toilet bowl, a biasing mechanism connected to the base portion, a seat portion hingedly connected to the base portion, the seat portion configured to rotate between a fully inclined position and a closed position, and at least one strut having a first end and a second end opposite the first end, the first end connected to the seat portion and the second end connected to the biasing mechanism, wherein the biasing device biases the seat portion into the inclined position. In one embodiment, the seat apparatus includes a first and second strut on opposite sides of the seat apparatus. In a further embodiment, the biasing mechanism comprises a first spring connected in series to a second spring. In yet another embodiment, the biasing mechanism comprises at least one hydraulic dampener. In an embodiment, the seat apparatus includes at least one hinge connected to the base portion, wherein the hinge is configured to hingedly connect the seat apparatus to the toilet bowl.

In a further embodiment, the seat apparatus includes a locking mechanism for locking the seat portion in the disinclined position, the locking mechanism comprising a latch connected to one of the seat portion and the base portion and a catch connected to the other. In one embodiment, the seat apparatus includes a release mechanism configured to disengage the locking mechanism, the release mechanism comprising a lock rod configured to selectively engage and disengage the catch, and a lever coupled to the lock rod, the lever configured to move the lock rod between the engaged and disengaged positions. In yet another embodiment, the seat apparatus includes a linkage connected at opposite ends to the lock rod and the lever, and at least one spring connected to the linkage, the spring configured to bias the lever into the engaged position. In one embodiment, the seat apparatus includes a fastening member configured to extend through an opening in the base portion and an opening between the first and second springs, the fastening member configured to increase the biasing force of the springs. In an embodiment, the seat apparatus includes a first cantilevered protrusion projecting outward from a first side of the base portion and a second cantilevered protrusion opposite the first. In one embodiment, the seat apparatus includes a first handle portion extending upward from the first cantilevered protrusion and a second handle portion extending upward from the second cantilevered protrusion. In yet a further embodiment, the seat apparatus includes a tang on a forward end of one of the seat portion and the base portion, and a clevis on the other one of the seat portion and the base portion, wherein the clevis is configured to receive the tang, and wherein the tang and clevis form a hinge about which the seat portion is configured to rotate between the fully inclined position and the closed position.

### BRIEF DESCRIPTION OF THE DRAWINGS

These and other features and advantages of the present invention will be better understood by reference to the following detailed description when considered in conjunction with the accompanying drawings. The same numbers are used throughout the figures to reference like features and components.

FIG. 1 is a perspective view of an embodiment of a toilet seat riser, comprising a seat assembly hingedly connected to a base assembly, in an inclined position;

FIG. 2A is a perspective view of an embodiment of the toilet seat riser in a closed position;

FIG. 2B is a perspective view of an embodiment of a handle illustrated in FIG. 2A;

FIG. 3 is a side view of an embodiment of the toilet seat riser in an inclined position;

FIG. 4 is a left-half bottom view of an embodiment of the toilet seat riser, showing a lock and release assembly in an engaged position;

FIG. 5 is a left-half bottom view of an embodiment of the toilet seat riser showing the lock and release assembly of FIG. 4 in a disengaged position;

FIG. 6A is a left-half bottom view of an embodiment of the toilet seat riser showing a spring housing coupled to base assembly;

FIG. 6B is a perspective view of the spring housing of FIG. 6A;

FIG. 6C is a left-half bottom view of an embodiment of the toilet seat riser, showing a cover plate coupled to the base assembly;

FIG. 7A is a front view of an embodiment of a latch and a catch in an engaged position; and

FIG. 7B is a front view of an embodiment of a latch and a catch in a disengaged position.

### DETAILED DESCRIPTION

The present invention relates generally to health care and assisted living equipment, and more particularly to a mechanized toilet seat apparatus. The drawings depict the invention as applied to a toilet for illustrative purposes only, and it will be apparent that the present invention may also be used in other applications, such as office chairs, couches, and car seats. An embodiment of the toilet seat riser 100 of the present invention is configured to attach to an existing toilet bowl following the removal of an existing toilet seat. In one embodiment, the toilet seat riser 100 is configured to attach to the toilet bowl using the same attachment points as a standard toilet seat. In use, the toilet seat riser 100 is configured to assist a user in gradually sitting down on the toilet and then gradually returning to a standing position following use of the toilet.

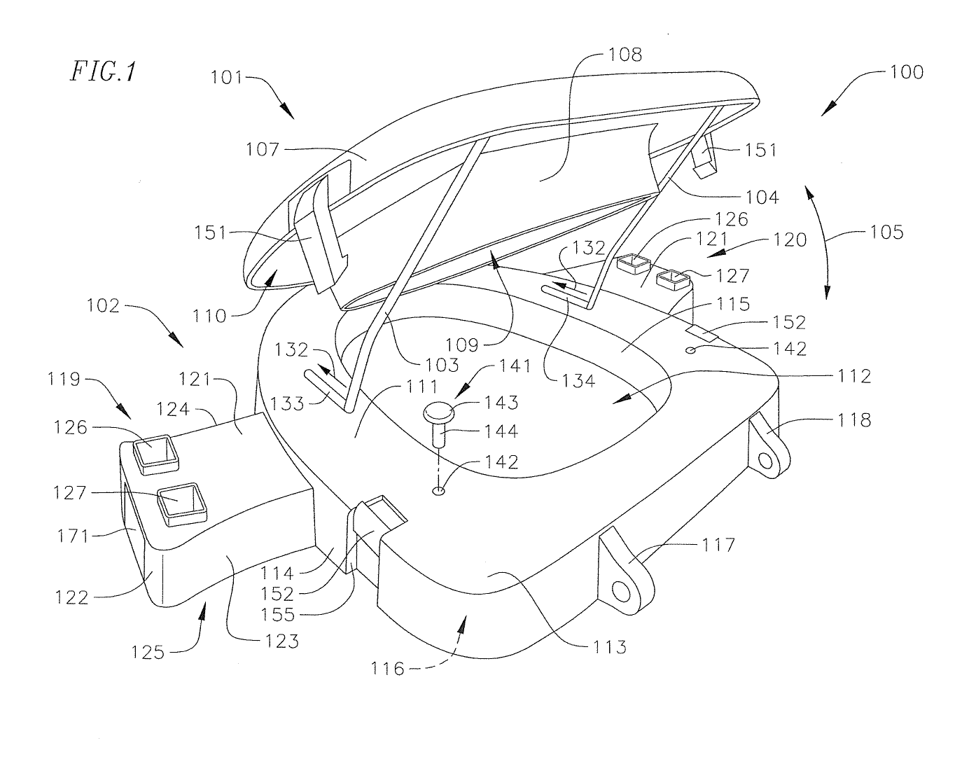

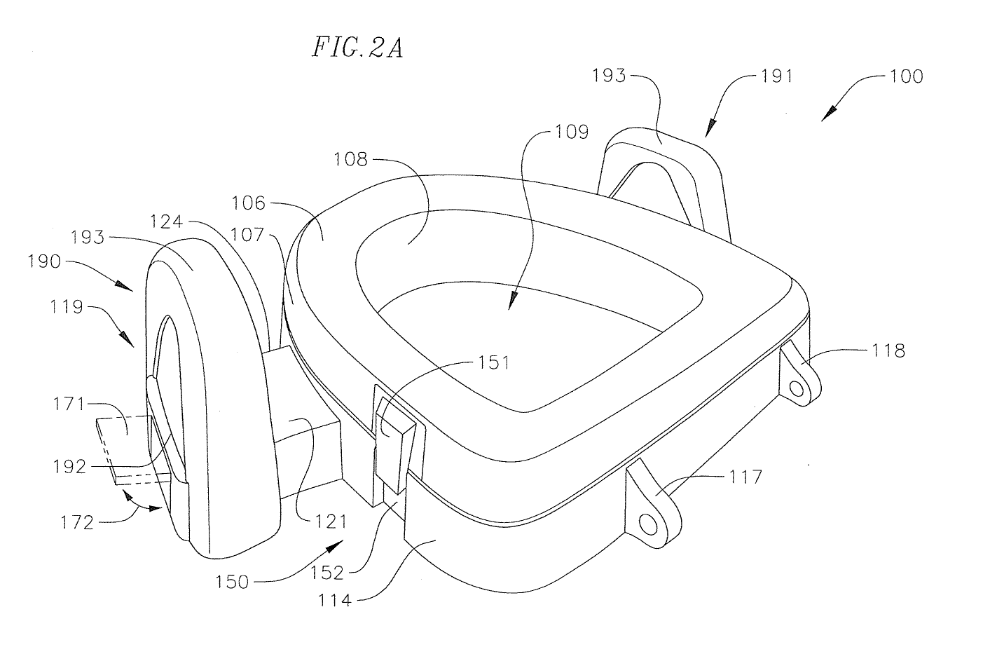

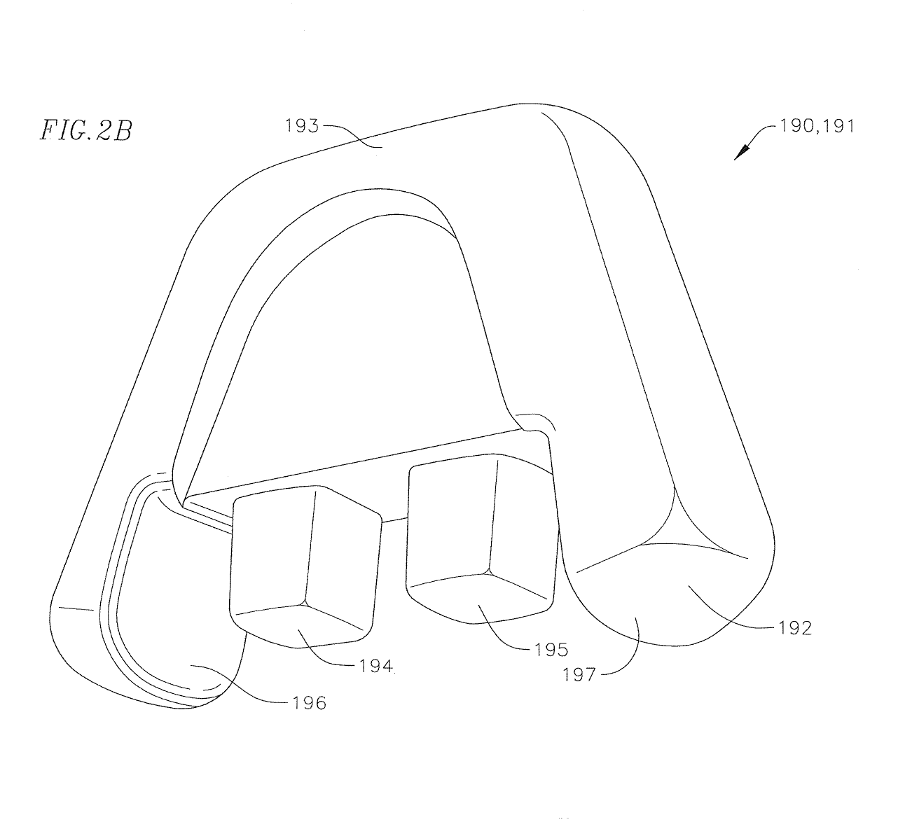

Referring now to an embodiment of the present invention illustrated in FIGS. 1 and 2A, the toilet seat riser 100 is comprised of a seat assembly 101 hingedly connected to a base assembly 102. The base assembly 102 is configured to removably connect to a toilet bowl and the seat assembly 101 is configured to support the user. A forward end of the seat assembly 101 is hingedly connected to the base assembly 102 about a fulcrum, and a rear end of the seat assembly 102 is supportably connected to the base assembly by two struts 103, 104. The seat assembly is configured to rotate (arrow 105) between an inclined position (FIG. 1) and a closed or retracted position (FIG. 2A). The inclined position of the seat assembly 101 corresponds to the standing/upright position of the user, and the closed position corresponds to the seated position of the user. The toilet seat assembly 100 is configured to move from the inclined position to the closed position under the weight of the user. As described in detail below, the toilet seat riser 100 is configured to provide a resistive force to assist the user into the seated position. That is, the toilet seat riser 100 provides a biasing force configured to slowly lower the seat assembly and the user into the seated position. The toilet seat riser 100 is also configured to provide an assistive force aiding the user in returning to the standing position. In one embodiment, when not in use, the seat assembly remains in the inclined position (FIG. 1) under the biasing force. In one embodiment, a plurality of springs, hydraulic dampers (i.e., dashpots), and/or motors, or any combination thereof, provides the force biasing the user into the upright/standing position and lowering the user into the seated position.

With continued reference to the embodiment illustrated in FIGS. 1 and 2A, the seat assembly 101 is comprised of a seat portion having a contoured wall 106, an exterior flange 107, and an interior flange 108. The contoured wall 106 is configured to receive and support the user during use of the toilet seat riser 100. The planform of the contoured wall 106 is ovaloid having a smaller, generally concentric ovaloid opening 109. The contoured wall 106 is formed from a relatively thin plate having an upper surface and a lower surface. The exterior flange 107 extends around the outer periphery of the contoured wall 106 and extends downward from the upper surface of the contoured wall 106. Similarly, the interior flange 108 extends around the interior periphery of the contoured wall 106 (i.e., the periphery defined by the ovaloid opening) and extends downward from the upper surface of the contoured wall 106. In the illustrated embodiment, the interior flange 108 extends lower than the exterior flange 107. Together, the contoured wall 106, the exterior flange 107, and the interior flange 108 form an inverted U-shaped cavity 110, which is configured to house various components described below. When the seat assembly 101 is in the closed position (FIG. 2A), the exterior flange 107 of the seat portion is configured to abut an upper surface 111 of the base assembly 102 and the interior flange 108 is configured to extend down into an ovaloid opening 112 in the base assembly 102. The contour of the interior flange 108 on the seat portion generally matches the contour of the ovaloid opening 112 in the base assembly 102 such that the interior flange 108 is configured to ensure proper alignment between the seat assembly 101 and the base assembly 102 when the toilet seat riser 100 is in the closed position (FIG. 2A). In this regard, the interior flange 108 functions as a guide ensuring the seat assembly 101 maintains proper alignment with the base assembly 102 during use.

With continued reference to the embodiment illustrated in FIGS. 1 and 2A, the base assembly 102 is comprised of a base portion having a base plate 113, an exterior lip 114, and an interior lip 115 opposite the exterior lip 114. In one embodiment, the shape of the base portion is substantially similar to the shape of the seat portion. In the illustrated embodiment, the base plate 113 is ovaloid and defines a generally concentric ovaloid opening 112 therein. In one embodiment, the base plate 113 is formed from a relatively thin plate having an upper surface and a lower surface. The exterior lip 114 extends around the outer periphery of the base plate 113 and extends downward from the upper surface 111 of the base plate 113. Similarly, the interior lip 115 extends around the interior periphery of the base plate 113 (i.e., the periphery defined by the ovaloid opening 112) and extends downward from the upper surface 111 of the base plate 113. Together, the base plate 113, the exterior lip 114, and the interior lip 115 form a cavity 116, which is configured to house various components described below. The base plate 113, the exterior lip 114, and the interior lip 115 may be formed as a single piece, such as by liquid injection molding, machining or rapid prototyping, or may be formed by as separate pieces which are subsequently joined together by any suitable means, such as bonding, welding, or fastening. In an alternate embodiment, the base portion of the base assembly 102 comprises a solid piece having a uniform thickness.

With continued reference to FIGS. 1 and 2A, the base assembly 102 also includes a pair of hinges 117, 118 connected to the exterior lip 114 of the base portion. The hinges 117, 118 extend rearwardly from the rear portion of the exterior lip 114. In one embodiment, the hinges 117, 118 are configured to attach to preexisting openings or fittings (not shown) on a toilet bowl. The hinges 117, 118 are configured to permit the user to rotate the toilet seat riser 100 out of the way when not in use. The hinges 117, 118 may be formed from separate parts and secured to the base portion by any suitable means, such as fastening, bonding, or welding. In an alternate embodiment, the hinges 117, 118 may be integrally formed with the base portion.

Still referring to FIGS. 1 and 2A, the base assembly 102 also includes two cantilevered protrusions 119, 120 extending outward from opposite sides of the base portion. In the illustrated embodiment, the protrusions 119, 120 extend outward from the arcuate portion of the exterior lip 114. Both of the protrusions 119, 120 are comprised of a horizontal plate 121 and three vertical sidewall portions 122, 123, 124 extending around the periphery of the horizontal plate 121. The horizontal plate 121 is formed from a relatively thin sheet having an upper surface and a lower surface. The sidewall portions 122, 123, 124 extend down from the upper surface of the horizontal plate 121. Together, the horizontal plate 121 and the sidewall portions 122, 123, 124 form a cavity 125 configured to house various components described below.

With continued reference to the embodiments illustrated in FIGS. 1 and 2A, the protrusions 119, 120 are also configured to support one or more handles 190, 191, respectively (see FIGS. 2A and 2B). In the illustrated embodiment of FIG. 1, both of the protrusions 119, 120 include two rectangular receptacles 126, 127 which are configured to connect the handles 190, 191 to the base assembly 102. In the embodiment illustrated in FIG. 2A, the handles 190, 191 extend upward from the outermost portions of the protrusions 119, 120. The handles 190, 191 are configured to aid the user in moving into the seated position and subsequently returning to the standing position. In the illustrated embodiment of FIG. 2B, both of the handles 190, 191 are generally trapezoidal and include a relatively wider lower end 192 which tapers to a relatively narrower upper end 193 opposite the lower end 192. Additionally, the lower end 192 of each of the handles 190, 191 includes two inner rectangular protrusions 194, 195 and two outer protrusions 196, 197. The two inner rectangular protrusions 194, 195 are configured to be received in the rectangular receptacles 126, 127, respectively, to attach the handles 190, 191 to the base assembly 102. The outer protrusions 196, 197 are configured to overhang sidewall portions 124, 123, respectively, of the two cantilevered protrusions 119, 120 when the handles 190, 191 are coupled to the base assembly 101. It will be appreciated, however, that the handles 190, 191 may have other suitable shapes and still fall within the scope and spirit of the present invention. In use, the user may grasp the free, upper end 193 of the handles 190, 191 and press downward against the handles 190, 191 such that the handles 190, 191 bear or support a portion of the user's weight and thereby aid in slowly lowering the user into the seated position. Additionally, the user may press downward against the handles 190, 191 when returning to the standing position. The handles 190, 191 may also laterally stabilize the user when moving between the seated and standing positions. The handles 190, 191 may be connected to the base assembly 102 by any suitable means, such as fastening, bonding, or welding. In an alternate embodiment, the handles 190, 191 may be integrally formed with the protrusions 119, 120.

The seat portion and the base portion may be formed from any suitably strong and durable material, such as aluminum alloy, carbon fiber reinforced plastic, steel, or polyvinyl chloride (PVC). Moreover, the seat portion and the base portion may be formed by any suitable process, for instance, liquid injection molding, welding, machining, or rapid prototyping using additive manufacturing.

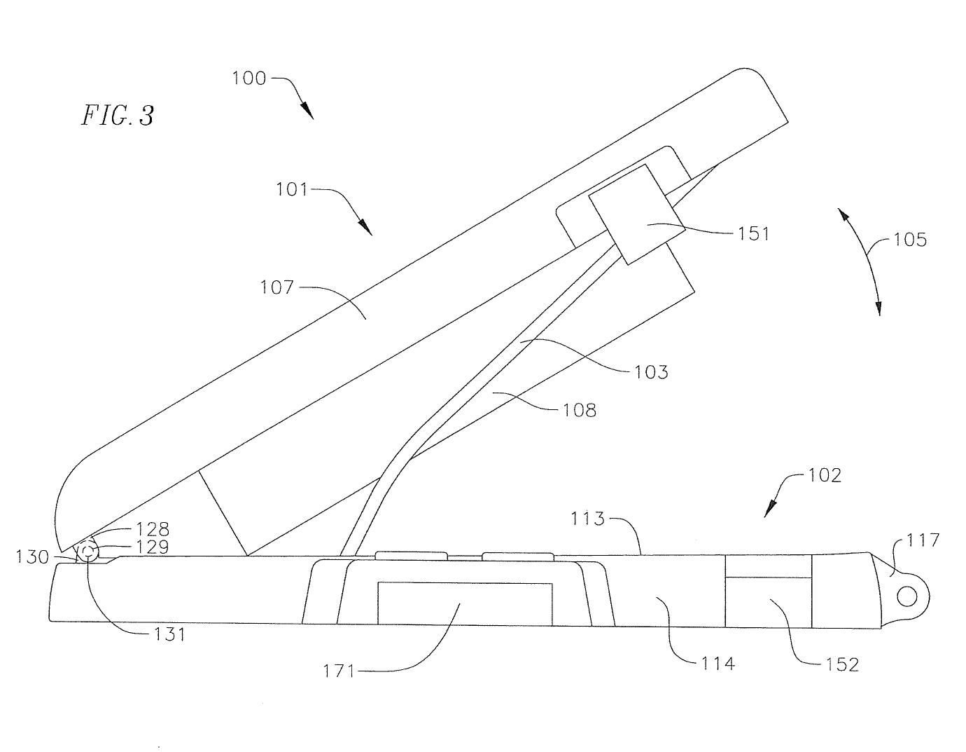

With reference now to the embodiment illustrated in FIG. 3, a forward end of the seat assembly 101 is hingedly connected to a forward end of the base assembly 102. In one embodiment, the hinged connection between the seat assembly 101 and the base assembly 102 is achieved by a clevis 128 rotatably connected to a tang 130. In the illustrated embodiment, the forward end of the seat assembly 101 includes a clevis 128 having two closely spaced legs. The clevis 128 may be integrally formed with the seat portion or formed separately and secured to the seat portion by any suitable means, such as fastening, bonding, or welding. The legs of the clevis 128 also include concentric through holes 129 for receiving a fastener. A lower end of the legs includes rounded portions which are configured to permit the seat assembly 101 to rotate (arrow 105) about the base assembly 102 between the inclined position (FIG. 1) and the closed position (FIG. 2A). The forward end of the base assembly 102 includes a tang 130 having a through hole 131. The tang 130 may be integrally formed with the seat portion or formed separately and secured to the seat portion by any suitable means, such as fastening, bonding, or welding. The tang 130 protrudes upward from an upper surface of the base portion and is laterally aligned with the clevis 128 on the seat assembly 101. An upper end of the tang 130 includes a rounded portion configured to permit the seat portion to rotate (arrow 105). The gap between the legs of the clevis 128 is configured to receive the tang 130 on the base portion (i.e., the tang 130 is configured to extend up into the gap between the legs of the clevis 128). In an embodiment, the width of the gap between the legs of the clevis 128 is slightly larger than the width of the tang 130. In an alternate embodiment, the gap between the legs of the clevis 128 may be substantially equal to the width of the tang 130 such that the tang 130 and clevis 128 are configured for a friction-fit connection. Moreover, the hole 131 in the tang 130 is configured to align with the holes 129 in the clevis 128. In one embodiment, the diameter of the hole 131 in the tang 130 is generally equal to the diameter of the holes 129 in the clevis 128. A fastener, such as a clevis pin, is configured to extend through the holes 129, 131 in the clevis 128 and tang 130, respectively, and thereby secure the clevis 128 to the tang 130. The fastener defines the fulcrum having a horizontal axis about which the seat assembly 101 is configured to rotate (arrow 105) between the inclined position (FIG. 1) and the closed position (FIG. 2A). In an alternate embodiment, the base assembly 102 may include a clevis and the seat assembly may include a tang configured to be received in the clevis. In an alternate embodiment, the toilet seat riser 100 may be provided without a clevis and tang.

With reference again to the embodiment illustrated in FIG. 1, the seat assembly 101 is connected to the base assembly 102 by two struts 103, 104 on opposite sides of the toilet seat riser 100. The struts 103, 104 are configured to provide lateral and vertical stability to the seat assembly 101 as the seat assembly rotates (arrow 105) between the inclined and closed positions. The struts 103, 104 are also configured to assist the user between the inclined position and the seated position. The struts 103, 104 are pivotally connected to the seat assembly 101 and slidably connected to the base assembly 102. Proximal ends of the struts 103, 104 are pivotally connected to the seat assembly 101, which permits the seat assembly 101 to rotate (arrow 105) between the inclined and closed positions. The proximal ends of the struts 103, 104 may be pivotally connected to the seat assembly 101 by any suitable means, such as with fasteners (e.g., a clevis and a clevis pin). Distal ends of the struts 103, 104 opposite the proximal ends are slidably connected to the base assembly 102. The distal ends of the struts 103, 104 are configured to slide (arrow 132) along slots 133, 134, such as a channels or grooves, in opposite sides of the base portion when the seat assembly 101 moves between the inclined position (FIG. 1) and the closed position (FIG. 2A). The slots 133, 134 in the base portion extend along the fore-aft direction of the base portion. As shown in FIG. 1, when the seat assembly 101 is in the inclined position, the distal ends of the struts 103, 104 are located near the rear ends of the slots 133, 134. In contrast, when the seat assembly 101 is in the closed position, the distal ends of the struts 103, 104 are located near the forward ends of the slots 133, 134. Moreover, when the seat assembly is in the closed position (FIG. 1), the struts 103, 104 are housed in the inverted U-shaped cavity 110 in the seat portion described above.

In the illustrated embodiment, the struts 103, 104 are comprised of generally cylindrical rods, although the struts 103, 104 may be any other suitable shape (e.g., square rods, tubes) and still fall within the scope and spirit of the present invention. Moreover, the struts 103, 104 may be generally straight, arcuate, or kinked, depending upon the desired load bearing capacity of the toilet seat riser 100. The struts 103, 104 may be formed from any suitably strong and durable material, such as aluminum alloy, carbon fiber reinforced plastic, steel, polyvinyl chloride (PVC).

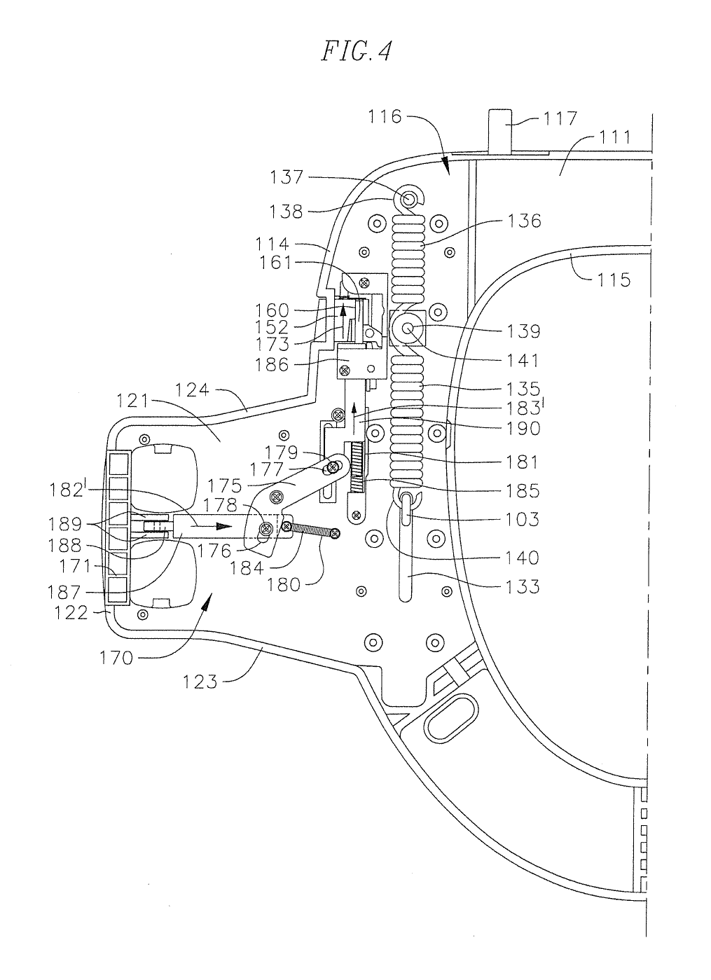

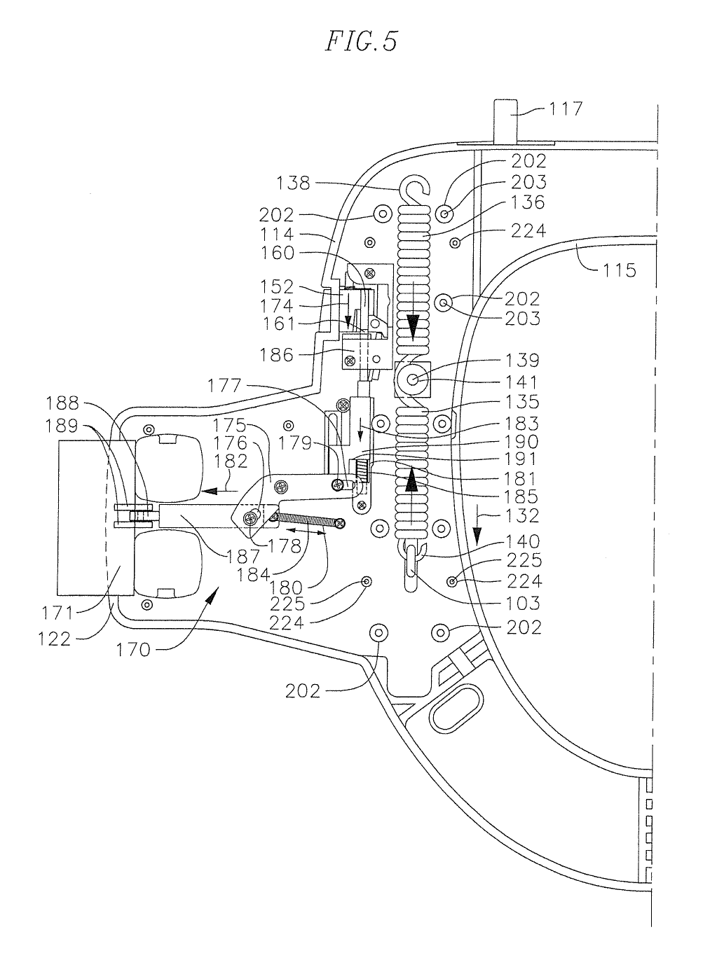

With reference now to the embodiment illustrated in FIGS. 4 and 5, the distal ends of the struts 103, 104 may be connected to a biasing mechanism configured to provide a force biasing the seat assembly 101 into the inclined position (FIG. 1). In the illustrated embodiment, both struts 103, 104 extend through the slots 133, 134 in the base portion, and are connected to a front spring 135 and a rear spring 136 connected in series. The distal ends of the struts 103, 104 may be connected to the forward end of the front springs 135 by any suitable means, such as fastening, bonding, or welding. In the illustrated embodiment, the distal ends of the struts 103, 104 are connected to hook eyes 140 on the forward ends of the front springs 135. When the seat assembly 101 rotates (arrow 105) into the closed position, the distal ends of the struts 103, 104 slide (arrow 132) toward the forward end of the slots 133, 134 and thereby elongate the springs 135, 136, as illustrated in FIG. 5. The elongation of the springs 135, 136 provides the force assisting and lowering the user into the seated position. Moreover, the energy stored in these elongated springs 135, 136 provides a force biasing the seat assembly 101 into the inclined position, which thereby assists the user into the standing/upright position. The energy stored in the springs 135, 136 is a function of the number of springs, the spring constant of the springs, and the displacement of the springs. In an alternate embodiment, the biasing mechanism may include hydraulic dampers (i.e., dashpots) or electric motors, alone or in combination with one or more springs, providing a force biasing the seat assembly into the inclined position.

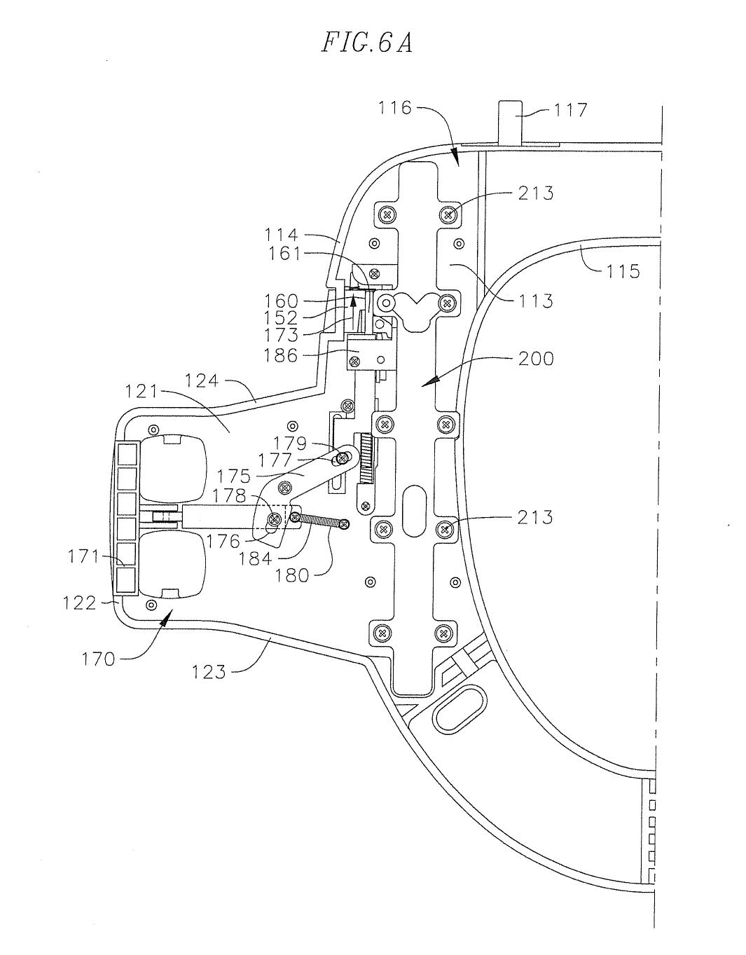

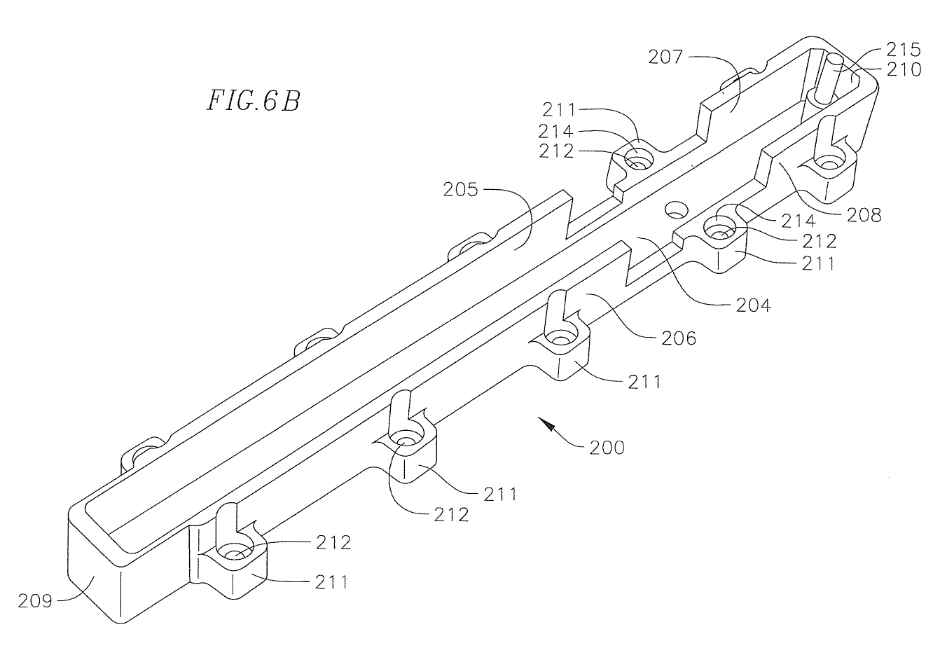

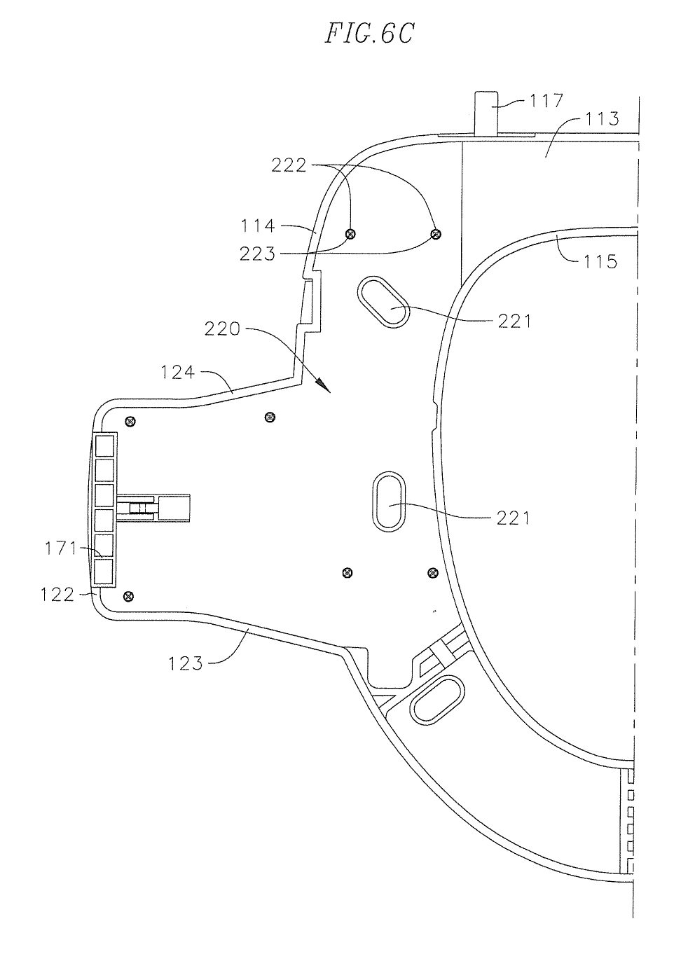

With reference now to FIGS. 6A and 6B, the base assembly 102 includes two spring housings 200 configured to cover the springs 135, 136. In the illustrated embodiment, the spring housings 200 are configured to be coupled to the base plate 113 by a plurality of fasteners 213, such as hex head screws. In one embodiment, a plurality of cylindrical receptacles 202 extend downward from the base plate 113 (see FIG. 5). Each of the cylindrical receptacles 202 includes an inner bore 203 configured to receive a portion of one of the fasteners 213 securing the spring housings 200 to the base plate 113. In one embodiment, the inner bores 203 of the cylindrical receptacles 202 are smooth and the fasteners securing the spring housings 200 to the base plate 113 are self-tapping. In an alternate embodiment, the inner bores 203 of the cylindrical receptacles 202 are threaded.

With continued reference to FIG. 6B, each of the spring housings 200 includes a generally flat plate 204 and six wall segments 205, 206, 207, 208, 209, and 210 extending upward from the flat plate 204. In the illustrated embodiment, the six wall segments 205, 206, 207, 208, 209, and 210 extend substantially around the entire periphery of the flat plate 204. The spring housings 200 also include a plurality of outwardly extending feet 211. In the illustrated embodiment, each of the feet 211 include an opening 212 configured to receive a portion of one of the fasteners 213 securing the spring housings 200 to the base plate 113. Each of the feet 211 may also include a cylindrical recess or depression 214 concentric with the openings 212 in the feet 211. The cylindrical depressions 214 are configured to receive a portion of the cylindrical receptacles 202 extending downward from the base plate 113 to ensure proper alignment between the spring housings 200 and the base plate 113 (i.e., the cylindrical depressions 214 are configured to ensure alignment between the openings 212 in the feet 211 and the inner bores 203 of the cylindrical receptacles 202). In the illustrated embodiment, the spring housings 200 each include ten feet 211, although it will be appreciated that the spring housings 200 can be provided with any other suitable number of feet 211 (e.g., between two and sixteen) depending upon the desired attachment strength between the spring housings 200 and the base plate 113. The spring housings 200 also include a cylindrical post 215 extending upward from the flat plate 204, the significance of which is explained below. In the illustrated embodiment, the cylindrical post 215 is located near one end of the flat plate 204.

As the seat assembly 101 moves between the inclined position (FIGS. 1 and 3) and the closed position (FIG. 2A), the distal ends of the struts 103, 104, which are connected to the forward ends of the front springs 135, slide along the flat plates 204 of the spring housings 200 (i.e., the spring housings 200 function as a track or guide along which the distal ends of the struts 103, 104 slide as the user moves the seat assembly 101 between the inclined position and the closed position). In this manner, the spring housings 200 are configured to prevent the struts 103, 104 from extending completely through the slots 133, 134 (see FIG. 1) in the base portion as the user moves the seat assembly 101 into the closed position. In one embodiment, the flat plates 204 of the spring housings 200 may be provided with a layer of friction-reducing material, such as grease, to promote the sliding engagement between the distal ends of the struts 103, 104 and the spring housings 200, and thereby prevent premature wear of the spring housings 200 and the struts 103, 104.

With reference now to the embodiment illustrated in FIG. 6C, two covers 220 may be provided to cover the various components housed in the cavity 116 formed by the base plate 113, the exterior lip 114, and the interior lip 115 of the base portion. The covers 220 are generally flat thin plates having a periphery configured to match the contour of the base portion. The covers 220 also include a plurality of bumpers 221 configured to engage the toilet bowl when the toilet seat riser 100 is attached to the toilet bowl. In the illustrated embodiment, each cover 220 includes two bumpers 221, although it will be appreciated that the cover 220 may be provided with any suitable number of bumpers 221, such as between one and ten. In an alternate embodiment, the covers 220 may be provided without the bumpers 221. The bumpers 220 may be made from any suitable material, such as an elastomeric material (e.g., rubber). The bumpers 221 are configured to prevent the toilet seat riser 100 from damaging the toilet bowl (i.e., the bumpers 221 are configured to prevent contact between the base portion of the toilet seat riser 100 and the toilet bowl, which contact might otherwise damage the toilet bowl). Each of the covers 220 also includes a plurality of openings 222 configured to receive a plurality of fasteners 223 coupling the covers 220 to the base plate 113 of the base portion. In one embodiment, the base portion includes a plurality of cylindrical receptacles 224 extending downward from the base plate 113 (see FIG. 5). Each of the cylindrical receptacles 224 includes an inner bore 225 configured to receive a portion of one of the fasteners securing the covers 200 to the base plate 113. The inner bores 225 of the cylindrical receptacles 224 are configured to align with the openings 222 in the covers 220. In one embodiment, the inner bores 225 of the cylindrical receptacles 224 are smooth and the fasteners securing the covers 220 to the base plate 113 are self-tapping. In an alternate embodiment, the inner bores 225 of the cylindrical receptacles 224 are threaded. The toilet seat riser 100 may be provided with any suitable number of fasteners 223 securing each cover 220 to the base plate 113, such as between one and ten.

With reference again to FIGS. 4 and 5, the front and rear springs 135, 136 are housed in the cavity 116 formed by the base plate 113, the exterior lip 114, and the interior lip 115 of the base portion. It will be appreciated that the spring housings 200 are not depicted in FIGS. 4 and 5 in order to show the springs 135, 136. In the illustrated embodiment, the rear springs 136 are configured to be connected at their rear ends to the cylindrical posts 215 on the spring housings 200. In the illustrated embodiment, the rear ends of the rear springs 136 include hook eyes 138 configured to engage the cylindrical posts 215 on the spring housings 200. In an alternate embodiment, the rear ends of the rear springs 136 may be attached to the base plate 113 rather than the posts 215 on the spring housings 200. The rear springs 136 may be connected to the base plate 113 by any suitable means, such as a fastening, bonding, or welding. The forward ends of the rear springs 136 are connected to the front springs 135. The forward ends of the rear springs 136 may be connected to the rear ends of the front springs 135 by any suitable means, such as fastening, bonding, or welding. In an alternate embodiment, the front and rear springs 135, 136 may be integrally formed as a single member such that both struts 103, 104 are connected to a single spring. The connection between the front and rear springs 135, 136 includes an opening 139 for selectively receiving a fastener, described in detail below.

With continued reference to FIGS. 4 and 5, the user may selectively adjust the biasing force of the springs 135, 136 to accommodate the user's weight. That is, the user may adjust the toilet seat riser 100 to provide a desired amount of resistive force when the user is moving into the seated position and a desired amount of assistive force when the user is moving into the standing position. The biasing force F_{Series} supplied by the front and rear springs 135, 136 connected in series is defined by the following equation,

F_{Series}=k_{eq}x=k₁x₁=k₂x₂

wherein k₁ is the spring constant of the rear spring 136, k₂ is the spring constant of the front spring 135, x₁ is the elongation of the rear spring 136, and x₂ is the elongation of the front spring 135. Moreover, k_{eq} is the equivalent spring constant of the front and rear springs 135, 136 in series and x is the total combined elongation of the front and rear springs 135, 136. From the equation above, it follows that the equivalent spring constant k_{eq} of the front and rear springs 135, 136 connected in series is as follows,

$${k}_{eq} ( {x}_{1} + {x}_{2} ) = {k}_{1} {x}_{1} = {k}_{2} {x}_{2}$$

$${x}_{1} = {x}_{2} \frac{{k}_{2}}{{k}_{1}}$$

$${k}_{eq} ( {x}_{2} \frac{{k}_{2}}{{k}_{1}} + {x}_{2} ) = {k}_{2} {x}_{2}$$

$${k}_{eq} = \frac{{k}_{2} {x}_{2}}{( {x}_{2} \frac{{k}_{2}}{{k}_{1}} + {x}_{2} )} = \frac{{k}_{2}}{( \frac{{k}_{2}}{{k}_{1}} + 1 )} = \frac{{k}_{2}}{\frac{{k}_{2} + {k}_{1}}{{k}_{1}}} = \frac{{k}_{1} {k}_{2}}{{k}_{2} + {k}_{1}} = \frac{1}{\frac{{k}_{2} + {k}_{1}}{{k}_{1} {k}_{2}}} = {( \frac{1}{{k}_{1}} + \frac{1}{{k}_{2}} )}^{- 1}$$

Accordingly, the biasing force F_{Series} supplied by the front and rear springs 135, 136 connected in series is as follows,

$${F}_{Series} = {x ( \frac{1}{{k}_{1}} + \frac{1}{{k}_{2}} )}^{- 1}$$

If the spring constants k1 and k2 of the front and rear springs 135, 136, respectively, are equivalent, then the biasing force F_{Series} supplied by the two springs 135, 136 connected in series is as follows,

$${F}_{Series} = \frac{1}{2} ( {k}_{1 , 2} x )$$

Accordingly, in the embodiments in which the spring constants k₁ and k₂ of the front and rear springs 135, 136 are equivalent, the biasing force F_{Series} supplied by the two springs 135, 136 in series is half of the biasing force of one of the springs acting separately.

To increase the load-bearing capacity of the toilet seat riser 100, the connection between the front and rear springs 135, 136, respectively, is configured to receive a fastener, such as a pin 141, as illustrated in FIG. 5. The pins 141 are configured to extend through openings, such as through holes 142, in the base portion and through the corresponding opening 139 between the front spring 135 and the rear spring 136. The through holes 142 are in opposite sides of the base portion and are aligned with the corresponding opening 139 between the front and rear springs 135, 136. As illustrated in FIG. 1, each pin 141 includes a head portion 143 and a shaft portion 144 extending down from the head portion 143. When the pins 141 are inserted into the openings between the front and rear springs 135, 136, the head portion 143 abuts the upper surface 111 of the base plate 113, and the shaft portion 144 extends through the opening 139 between the front and rear springs 135, 136. The pins 141 are configured to prevent the rear springs 136 from elongating when the seat assembly 101 is rotating (arrow 105 in FIG. 1) into the closed position. Specifically, when the pins 141 are inserted between the front and rear springs 135, 136, the rear spring 136 is fixed at both ends to the base portion, which prevents the rear spring 136 from elongating (i.e., the rear spring 136 is fixed at its rear end to the cylindrical post 215 on the spring housing 200 and fixed at its forward end by the pin 141 extending through the base plate 113). In this way, the rear spring 136 is disengaged and only the forward spring 135 is configured to elongate when the pin 141 is inserted into the opening 139 between the front and rear springs 135, 136. Accordingly, when the pin 141 is inserted between the springs 135, 136, the biasing force Fₚᵢₙ of the front spring 135 acting alone is defined by the following equation,

Fₚᵢₙ=k₂x

As shown by reference to the equation above describing the biasing force F_{Series} of the springs 135, 136 acting in series, inserting the pin 141 between the front and rear springs 135, 136 increases the biasing force of the spring assembly, and thereby increases the load bearing capacity of the toilet seat riser 100. In the embodiment in which the spring constants k₁ and k₂ are equal, the biasing force Fₚᵢₙ of the spring assembly when the pin 141 is inserted is twice the biasing force F_{Series} of the spring assembly without the pin inserted. The equations described above are introduced for illustrative purposes only, and are not intended to limit the scope of the present invention.

In one embodiment, the front and rear springs 135, 136 connected in series are configured to provide a maximum biasing force of approximately 250 pounds. In one embodiment, the front springs 135 acting independently are configured to provide a maximum biasing force of approximately 500 pounds. In an alternate embodiment, the spring constants of the front and rear springs 135, 136 may be selected such that the maximum biasing force of the front and rear springs 135, 136 connected in series exceeds 250 pounds, such as 350 pounds, and the maximum biasing force of the front springs 135 acting independently exceeds 500 pounds, such as 700 pounds. It will be appreciated, however, that the biasing force of the springs is not limited to the values recited above, and any desired force may be achieved by selecting springs with the appropriate spring constant and elongation distance.

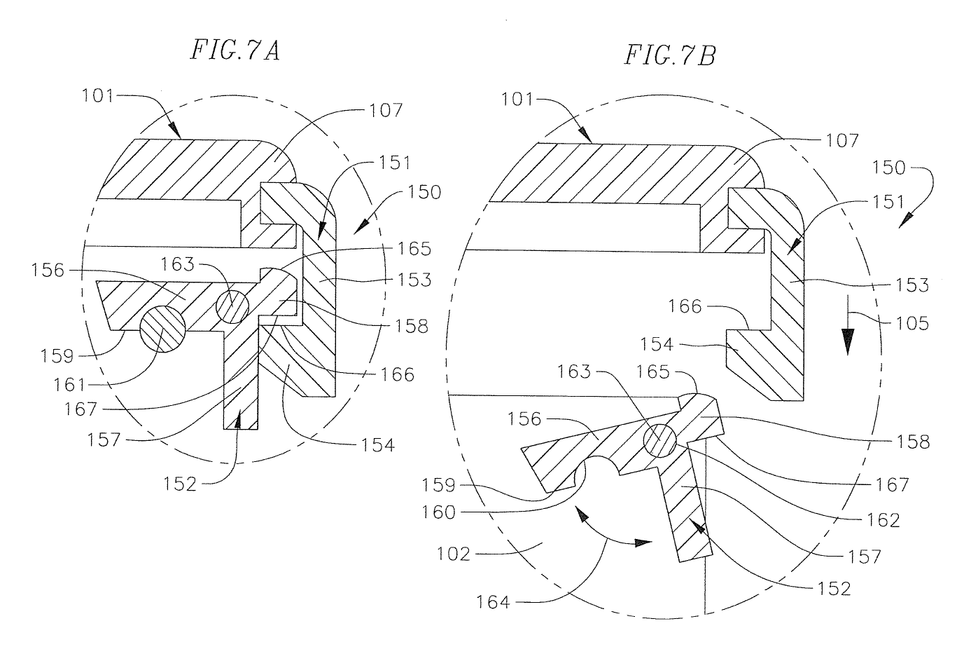

With reference now to the embodiment illustrated in FIGS. 7A and 7B, the toilet seat riser 100 includes two lock mechanisms 150 configured to lock the seat assembly 101 into the closed position (FIG. 2A). Otherwise, the springs 135, 136 would provide a biasing force tending to force the user into the standing position, which would interfere with the user's use of the toilet. The lock mechanisms 150 are also configured to disengage the seat assembly 101 from the locked, seated position when the user desires to return to the upright/standing position. In the illustrated embodiment, the toilet seat riser 100 includes two lock mechanisms 150 on opposite sides of the toilet seat riser 100, as illustrated in FIG. 1. It will be appreciated, however, that the toilet seat riser 100 may be provided with a single lock mechanism 150, or without a lock mechanism, and still fall within the scope and spirit of the present invention.

With continued reference to FIGS. 7A and 7B, both of the lock mechanisms 150 are comprised of a latch 151 connected to the seat assembly 101 and a catch 152 connected to the base assembly 102. The latch 151 is configured to engage the catch 152 and thereby secure the seat assembly 101 to the base assembly 102 in the closed position (FIG. 2A). In one embodiment, the latch 151 is comprised of a vertical wall segment 153 and a lip portion 154 extending inward from a lower end of the vertical wall segment 153. An upper end of the vertical wall segment 153 is connected to the exterior flange 107 of the seat portion. Together, the vertical wall segment 153 and the lip portion 154 form a hook configured to engage the catch 152. The latch 151 extends downward from the exterior flange 107 of the seat portion and extends below a lower edge of the exterior flange 107.

Still referring to FIGS. 7A and 7B, each catch 152 is rotatably connected to the base portion and is housed in a recess 155 in the exterior lip 114 of the base portion, as illustrated in FIG. 1. Each catch 152 is aligned with a corresponding latch 151 on the seat portion. Each catch 152 is comprised of a horizontal wall segment 156 and a vertical wall segment 157. An outer end of the horizontal wall segment 156 is joined to the upper end of the vertical wall segment 157. Moreover, a portion of the horizontal wall segment 156 extends outward beyond the vertical wall segment 157 (i.e., a portion of the horizontal wall segment 156 overhangs the vertical wall segment 157). Together, the vertical and horizontal wall segments 156, 157 form a generally T-shaped catch 152. The portion of the horizontal wall segment 156 that overhangs the vertical wall segment 157 forms a flange 158 for selectively engaging the lip portion 154 of the latch 151. Moreover, a lower surface 159 of the horizontal wall segment 156 includes a recess, such as a hemispherical groove 160, for selectively receiving a lock rod 161, as described in detail below. Each catch 152 also includes an opening 162 configured to receive a pivot 163 about which the catch 152 is configured to rotate (arrow 164), the purpose of which is described below. In one embodiment, the opening 162 is a longitudinal through hole. The pivot 163 is connected at opposite ends to the base portion and extends through the opening 162 in the catch 152. In one embodiment, the pivot 163 may be integrally formed in the exterior lip 114 of the base portion.

As the seat assembly 101 rotates (arrow 105) into the closed position (FIG. 2A), the lip portion 154 of the latch 151 is configured to contact the flange portion 158 of the catch 152. When the catch 152 is contacted by the latch 151, the catch 152 is configured to rotate (arrow 164) inwardly about the pivot 163. The inward rotation of the catch 152 permits the seat assembly 101 to continue down into the closed position wherein the lip 154 of the latch 151 is below the flange portion 158 of the catch 152, as shown in FIG. 7A. In one embodiment, the latch 151 may deflect outward when the lip 154 contacts the flange portion 158 of the catch 152, thereby permitting the lip portion 154 of the latch 151 to slide down below the flange 158. Moreover, an upper portion of the flange 158 may include a rounded edge 165 configured to permit the lip 154 of the latch 151 to slide below the flange 158. When the lip portion 154 of the latch 151 passes below the flange portion 158 of the catch 152, the catch 152 is configured to rotate (arrow 164) outwardly about the pivot 163 and return to its original position, as shown in FIG. 7A. In the position illustrated in FIG. 7A, an upper surface 166 of the lip 154 abuts a lower surface 167 of the flange 158, which locks the seat assembly 101 in the closed position (FIG. 2A) and prevents the seat assembly 101 from inadvertently returning to the inclined position (FIG. 1) under the force of the springs 135, 136.

As shown in FIG. 7A, the lock rod 161 prevents the catch 152 from rotating (arrow 164) outwardly when the upper surface 166 of the lip 154 engages the lower surface 167 of the flange 158. The lock rod 161 is recessed in the hemispherical groove 160 in the lower surface 159 of the horizontal wall segment 156 which thereby supports the horizontal wall segment 156 and prevents the catch 152 from rotating (arrow 164) outwardly. Otherwise, the outward rotation (arrow 164) of the catch 152 would enable the lip 154 of the latch 151 to disengage the flange portion 158 of the catch 152, which would cause the seat assembly 101 to rotate (arrow 105) into the inclined position (FIG. 1) under the force of the springs 135, 136. As described below, the toilet seat riser 100 includes two release mechanisms 170 on opposite sides of the base assembly 102 configured to enable the user to alternately engage and disengage the lock rod 161 from the catch 152, which allows the user to move between the locked, seated position (FIG. 2A) and the inclined position (FIG. 1).

With reference again to FIGS. 4 and 5, each release assembly 170 comprises a lever 171 coupled to the lock rod 161. The lever 171 is configured to rotate (arrow 172) between a depressed position and an extended position, as illustrated in FIG. 2A. When the lever 171 is rotated (arrow 172) into the depressed position, the lock rod 161 slides rearward (arrow 173 in FIG. 4) and engages the hemispherical groove 160 in the catch 152, which thereby locks the seat assembly 101 in the closed position (FIG. 2A) (i.e., rotating the lever 171 into the depressed position slides the lock rod 161 into locking engagement with the catch 151, as shown in FIGS. 4 and 7A). When the lever 171 is rotated (arrow 172) into the extended position, the lock rod 161 slides forward (arrow 174 in FIG. 5) and disengages the catch 152, which thereby permits the seat assembly 101 to rotate (arrow 105) into the inclined position (FIG. 1) (i.e., rotating the lever 171 into the extended position slides the lock rod 161 out of locking engagement with the catch 151, as shown in FIGS. 5 and 7B). Thus, the user pulls the lever 171 to return to the upright/standing position.

With continued reference to FIGS. 4 and 5, the lever 171 is coupled to the lock rod 161 by a linkage 175 rotatably coupled at opposite ends to the lever 171 and the lock rod 161. In the illustrated embodiment, the linkage 175 is comprised of a relatively thin L-shaped plate having slots 176, 177 at opposite ends. The slots 176, 177 are configured to receive fasteners 178, 179 coupling the linkage 175 to the lever 171 and the lock rod 161, respectively. Moreover, the ends of the linkage 175 may be slidably coupled to channels 180, 181. As the lever 171 is extended (arrow 172 in FIG. 2A), the linkage 175 slides (arrow 182 in FIG. 5) outward along the first channel 180 and forward (arrow 183 in FIG. 5) along the second channel 181. In contrast, when the lever 171 is rotated (arrow 172 in FIG. 2A) into the depressed position, the linkage 175 slides inward (arrow 182′ in FIG. 4) along the first channel 180 and backward (arrow 183′ in FIG. 4) along the second channel 181.

In the illustrated embodiment of FIGS. 4 and 5, the release assemblies 170 include springs 184, 185 configured to provide a force biasing the lever 171 into the depressed position. After the user pulls the lever 171 into the extended position to return to the standing position, the springs 184, 185 bias the lever 171 into the depressed position such that the lock rod 161 is configured to lock the seat assembly 101 into the closed position (FIG. 2A). In the illustrated embodiment, the first channel 180 houses spring 184 coupled to the linkage 175. As the lever 171 rotates (arrow 172 in FIG. 2A) into the extended position, the spring 184 elongates and thereby provides a restorative force which tends to rotate the linkage 175 and pull the lever 171 into the depressed position. Moreover, in the illustrated embodiment, the second channel 181 houses spring 185 coupled to the opposite end of the linkage 175. As the lever 171 moves into the extended position, the spring 185 compresses and thereby provides a restorative force which tends to rotate the linkage 175 and pull the lever 171 into the depressed position.

In the illustrated embodiment of FIGS. 4 and 5, the linkage 175 is coupled to the lever 171 by a connection rod 187. The connection rod 187 is connected at one end to the linkage 175 by fastener 178 and connected at an opposite end to the lever 171 by a tang 188. The end of the connection rod 187 connected to the linkage 175 is also connected to spring 184. In the illustrated embodiment, the lever 171 includes a clevis 189 having two closely spaced legs configured to receive the tang 188 on the connection rod 187. The tang 188 on the connection rod 187 may be rotatably coupled to the clevis 189 on the lever 171 by any suitable means, such as a clevis pin. The restorative force supplied by spring 184 is configured to pull the connection rod 187 inward and thereby pull lever 171 into the depressed position, as shown in FIG. 4.

In the illustrated embodiment of FIGS. 4 and 5, the linkage 175 is coupled to the lock rod 161 by a connection block 190. The connection block 190 is connected at one end to the linkage 175 by fastener 179 and connected at an opposite end to the lock rod 161. In one embodiment, the connection block 190 and the lock rod 161 may be integrally formed. In the illustrated embodiment, the connection block 190 includes a lip or step 191 configured to abut one end of spring 185. The restorative force supplied by spring 185 is configured to push the connection block 190 rearward and thereby move the lock rod 161 into locking engagement with the catch 152, as shown in FIG. 4.

The release assemblies 170 may also include a guide 186 connected to the lower surface of the base portion. The guide 186 is configured to slidably receive and support the lock rod 161. As illustrated in FIGS. 4 and 5, the guide 186 is configured to ensure the lock rod 161 maintains proper alignment with the hemispherical groove 160 in the catch 152 as the lock rod 161 moves between the engaged (FIG. 4) and disengaged positions (FIG. 5).

In use, the user first sets the load bearing capacity of the toilet seat riser 100. As described above, the load bearing capacity of the toilet seat riser 100 may be increased by inserting one or more pins 141 between the front and rear springs 135, 136 connected in series to disengage the rear spring 136. The user may then sit down on the inclined seat assembly 101, illustrated in FIG. 1. The weight of the user compresses the springs 135, 136 housed in the base assembly 102 which are connected to the seat assembly 101 by struts 103, 104. The assistive force supplied by the compressed springs 135, 136 slowly lowers the user down into the seated position, as illustrated in FIG. 2A. When the seat assembly 101 is in the closed position (FIG. 2A), the latch 151 engages the catch 152 and thereby locks the seat assembly 101 into the closed position. When the user desires to return to the inclined/standing position, the user rotates (arrow 172 in FIG. 2A) the lever 171 from the depressed position and into the extended position. Rotating the lever 171 into the extended position causes the lock rod 161 to disengage the catch 152, as illustrated in FIG. 5. The disengaged catch 152 will then rotate inward about the pivot 163, permitting the latch 151 to disengage the catch 152, as shown in FIG. 7B. The compressed springs 135, 136 will then provide a force biasing the user and the seat assembly 101 into the inclined position (FIG. 1). After the seat assembly 101 has begun to rotate (arrow 105) into the inclined position, the user may release the levers 171, which rotate (arrow 172 in FIG. 2A) back into the depressed position under the force of the springs 184, 185 connected to levers 171 by the linkages 175. The seat assembly 101 remains in the inclined position (FIG. 1) under the biasing force of the springs 135, 136 until the user again sits down on the seat assembly 101.

While this invention has been described in detail with particular references to exemplary embodiments thereof, the exemplary embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims. Although relative terms such as “outer,” “inner,” “upper,” “lower,” “below,” “above,” “vertical, “horizontal” and similar terms have been used herein to describe a spatial relationship of one element to another, it is understood that these terms are intended to encompass different orientations of the various elements and components of the device in addition to the orientation depicted in the figures. Moreover, the figures contained in this application are not necessarily drawn to scale.

What is claimed is:

1. A seat apparatus, comprising:
a base portion configured to mount to a toilet bowl proximate a rear portion of the base portion;
a biasing mechanism connected to the base portion proximate a forward portion of the base portion;
a seat portion hingedly connected to the forward portion of the base portion, the seat portion configured to rotate between a fully inclined position and a closed position; and
at least one strut having a first end and a second end opposite the first end, the first end connected to the seat portion and the second end connected to the biasing mechanism,
wherein the biasing mechanism biases the seat portion into the inclined position.

2. The apparatus of claim 1, wherein the at least one strut comprises a first and second strut on opposite sides of the seat apparatus.

3. The apparatus of claim 1, wherein the biasing mechanism comprises a first spring connected in series to a second spring.

4. The apparatus of claim 1, wherein the biasing mechanism comprises at least one hydraulic dampener.

5. The apparatus of claim 1, further comprising at least one hinge connected to the base portion, the hinge configured to hingedly connect the seat apparatus to the toilet bowl.

6. The apparatus of claim 1, wherein the fully inclined position of the seat portion forms an angle with the base portion between approximately 15 degrees and approximately 45 degrees.

7. The apparatus of claim 1, further comprising a locking mechanism for locking the seat portion in the disinclined position, the locking mechanism comprising a latch connected to one of the seat portion and the base portion and a catch connected to the other.

8. The apparatus of claim 7, further comprising a release mechanism configured to disengage the locking mechanism, the release mechanism comprising:
a lock rod configured to selectively engage and disengage the catch; and
a lever coupled to the lock rod, the lever configured to move the lock rod between the engaged and disengaged positions.

9. The apparatus of claim 8, further comprising:
a linkage connected at opposite ends to the lock rod and the lever; and
at least one spring connected to the linkage, the spring configured to bias the lock rod into the engaged position.

10. The apparatus of claim 3, further comprising a fastening member configured to extend through an opening in the base portion and an opening between the first and second springs, the fastening member configured to increase the biasing force of the springs.

11. The apparatus of claim 1, further comprising a first cantilevered protrusion projecting outward from a first side of the base portion and a second cantilevered protrusion opposite the first.

12. The apparatus of claim 11, further comprising a first handle portion extending upward from the first cantilevered protrusion and a second handle portion extending upward from the second cantilevered protrusion.

13. The apparatus of claim 1, further comprising:
a tang on a forward end of one of the seat portion and the base portion; and
a clevis on the other one of the seat portion and the base portion, wherein the clevis is configured to receive the tang, and wherein the tang and clevis form a hinge about which the seat portion is configured to rotate between the fully inclined position and the closed position.

14. A toilet, comprising:
a toilet bowl;
a seat apparatus, comprising:
a base portion hingedly connected to the toilet bowl;
a first and second spring connected in series and connected to the base portion;
a seat portion hingedly connected to a forward end of the base portion, the seat portion configured to rotate between a fully inclined position and a closed position; and
at least one strut having a first end and a second end opposite the first end, the first end connected to the seat portion and the second end connected to one of the first and second springs,
wherein the first and second springs are configured to bias the seat portion into the inclined position.

15. The toilet of claim 14, further comprising:
a latch connected to one of the seat portion and the base portion; and
a catch connected to the other, wherein the latch is configured to engage the catch and releasably lock the seat portion in the closed position.

16. The toilet of claim 14, further comprising a release mechanism configured to disengage the latch from the catch, the release mechanism comprising:
a lock rod configured to selectively engage and disengage the catch; and
a lever coupled to the lock rod, the lever configured to move the lock rod between the engaged and disengaged positions.

17. A method of assisting a user between a standing position and a seated position on a toilet using an apparatus comprising a base portion connected to the toilet, a spring mechanism connected to the base portion, a seat portion hingedly connected to the base portion, at least one strut connected at opposite ends to the seat portion and the spring, at least one latch connected to the seat portion, and at least one catch connected to the base portion, the method comprising:
compressing the spring mechanism, the compressed spring mechanism providing a resistive force assisting the user between the standing position and the seated position on the toilet.

18. The method of claim 17, further comprising selectively adjusting the resistance of the spring mechanism to provide the desired resistive force.

19. The method of claim 17, further comprising actuating the latch to engage the catch, the engaged catch securing the seat portion in a closed position.

20. The method of claim 19, further comprising actuating a release mechanism connected to the latch to disengage the latch from the catch, the disengaged latch causing the compressed spring mechanism to provide a force assisting the user into the standing position.
